(19) United States
(12) Patent Application Publication
(10) Pub. No.: US 2013/0296193 A1
(43) Pub. Date: Nov. 7, 2013

(54) METHOD FOR DISCOVERING A BIOMARKER

(71) Applicant: LG ELECTRONICS INC., Seoul (KR)

(72) Inventors: Hyung-Seok CHOI, Seoul (KR); Hae Seok EO, Seoul (KR); Jee Yeon HEO, Seoul (KR)

(73) Assignee: LG ELECTRONICS INC., Seoul (KR)

(21) Appl. No.: 13/653,849

(22) Filed: Oct. 17, 2012

(30) Foreign Application Priority Data
May 7, 2012 (KR) 10-2012-0048110

(51) Int. Cl. C40B 40/06; G06F 19/10

(52) U.S. Cl. 506/16; 702/19

(57) ABSTRACT

The invention relates to a method for discovering biomarkers, comprising: matching the expression levels of genetic factors in persons, including a plurality of patients having a specific disease, for each of the persons; and comparing the expression levels of the genetic factors and genes corresponding thereto by any one or more of cluster analysis and correlation analysis to select some of the genetic factors. According to the invention, highly accurate biomarkers for a specific disease can be discovered in a simple and easy manner.

### BACKGROUND OF THE INVENTION

1. Field of the Invention

The present invention relates to a method for discovering biomarkers, and more particularly, to a method of simply and easily discovering highly accurate biomarkers for a specific disease by comparing the expression levels of genetic factors and genes corresponding thereto by analysis of any one or more of cluster analysis and correlation analysis.

2. Description of the Prior Art

Breast cancer is a heterogeneous disease with respect to clinical behavior and response to therapy. This variability is a result of the differing molecular make-up of cancer cells within each subtype of breast cancer. However, only two molecular characteristics are currently being exploited as therapeutic targets. These are estrogen receptor (ER) and HER2, which are targets of antiestrogens (tamoxifen and aromatase inhibitors) and HERCEPTIN®, respectively. Efforts to target these two molecules have proven to be extremely productive. Nevertheless, those tumors that do not have these two targets are often treated with chemotherapy, which generally targets proliferating cells.

Since some important normal cells are also proliferating, they are damaged by chemotherapy at the same time. Therefore, chemotherapy is associated with severe toxicity. Identification of molecular targets in tumors in addition to ER or HER2 is critical in the development of new anticancer therapy.

Thus, it can be seen that the development and progression of cancer is not caused by some specific genes, but results from the complex interaction of many genes which are involved in various signaling mechanisms and regulatory mechanisms which occur during the progression of cancer. Accordingly, studies on the mechanisms of cancer formation, focused on some specific genes, are very limited studies. Thus, new genes related to cancer need to be identified by comparatively analyzing the expression levels of a large amount of genes between normal cells and cancer cells.

### SUMMARY OF THE INVENTION

Accordingly, the present invention has been made in view of the problems occurring in the prior art, and it is an object of the present invention to discover a highly accurate biomarker for a specific disease in a simple and easy manner.

To achieve the above object, the present invention provides a method for discovering biomarkers, comprising the steps of: matching the expression levels of genetic factors in persons, including a plurality of patients having a specific disease, for each of the persons; and comparing the expression levels of the genetic factors and genes corresponding thereto by analysis of any one or more of cluster analysis and correlation analysis to select some of the genetic factors.

Herein, the genetic factor is preferably one or more selected from the group consisting of chromosomal genes, single nucleotide polymorphisms (SNPs), copy-number variations (CNVs) and micro-RNAs (miRNAs).

In one embodiment of the present invention, matching the expression levels of the genetic factors for each of the persons may be performed by matching the expression levels of genes on the chromosome of the plurality of patients having the specific disease for each of the patients, and the analysis of any one or more may comprise the steps of selecting information about genes related to the specific disease from among the genes; analyzing the expression patterns of the selected genes in the patients according to the type of the disease; and clustering the genes according to the expression patterns.

Herein, selecting only the information about genes related to the specific disease from among the genes may be performed by selecting only information about genes known to be related to the specific disease.

Also, analyzing the expression patterns of the selected genes in the patients according to the type of the disease may be performed by dividing the expression patterns of the genes in the patients according to the disease type into two or more levels.

Moreover, the step of clustering the genes according to the expression patterns preferably comprises a step of selecting only genes which may be clustered according to the expression patterns, and selecting the selected genes as markers related to subtyping of the specific disease.

In another embodiment of the present invention, matching the expression levels of the genetic factors for each of the persons may be performed by matching the expression levels of single nucleotide polymorphisms (SNPs) and genes on the chromosomal of the plurality of patients having the specific disease for each of the patients, and the analysis of any one of more may comprise the steps of selecting a copy-number variation (CNV) region in which the expression levels of the SNPs are higher or lower than a specific reference value, and selecting CNVs present on effective at the location on the chromosome of the CNV region; and performing correlation analysis of the expression levels of the selected CNVs and genes corresponding thereto on the chromosomes of the patients to select genes showing positive (+) correlation.

Herein, the effective genes are preferably sequences containing genetic information.

Also, selecting the CNVs may be performed by selecting a CNV region in which the expression levels of the SNPs are higher than a first reference value or lower than a second reference value, and selecting CNVs present on sequences containing genetic information at the location on the chromosome of the CNV region.

In still another embodiment, matching the expression levels of the genetic factors for each of the persons may be performed by matching the expression levels of micro-RNAs (miRNAs) and genes in the persons, including the plurality of patients having the specific decrease, for each of the persons, and the analysis of any one or more may comprise a step of performing correlation analysis of the miRNAs and genes corresponding thereto to select genes showing negative (−) or positive (+) correlation, and selecting genes corresponding to miRNAs related to the specific disease from among the selected genes showing negative (−) or positive (+) correlation.

Herein, the miRNAs related to the specific disease are preferably miRNAs known to be related to the specific disease.

In still another embodiment of the present invention is directed to a method for discovering biomarkers by mechanism analysis, the method comprising the steps of

classifying genes, belonging to a candidate gene group suitable for use as biomarkers of disease, as a group related to the mechanism of action of a specific disease; and

comparing the expression levels of genes of the classified group in a plurality of patient groups having the specific disease and a normal person group to select genes which are expressed more highly in the patient groups.

Herein, the candidate gene group preferably includes genes obtained by the above biomarker discovery method.

Also, the candidate group includes genes obtained by the method for discovering biomarkers for subtyping, genes obtained by the method of discovering copy-number variations (CNVs), and genes obtained by the method of discovering biomarkers by micro-RNA (miRNAs).

Further, classifying the genes belonging to the candidate gene group as the group related to the mechanism of action of the specific disease may be performed by comparing the expression levels of genes between the plurality of patient groups having the specific disease and the normal person group to select a mechanism of action of a disease, including genes which are expressed more highly in the patient groups, as a group related to be the mechanism of action of the specific disease.

In addition, selecting the genes which are expressed more highly in the patient groups having the specific disease may be performed by selecting the genes, which are more highly expressed in the patient groups, by performing T-test for the patient groups having the specific disease and the normal person group.

Moreover, comparing the expression levels of genes of the classified group to select genes which are expressed more highly in the patient groups is preferably performed by first performing T-test for genes of the classified group, which have high expression levels, to select genes which are more highly expressed in the patient groups.

Still another embodiment of the present invention is directed to breast cancer-related biomarkers including genes shown in Table 1.

Also, the present invention is directed to biomarkers allowing the identification of subtypes of breast cancer.

In addition, the present invention is directed to a breast cancer test kit comprising: a microarray including probes corresponding to the biomarkers; and an optical measurement device for measuring changes in expressions of the genes.

Details of other embodiments are included in the detailed description and the accompanying drawings:

### BRIEF DESCRIPTION OF THE DRAWINGS

FIG. 1 is an example of a matching table showing the expression levels of genes in each patient, which is used in a method for discovering biomarkers for subtyping according to a preferred embodiment of the present invention.

FIG. 2 is an example of the expression pattern of each gene in a patient according to each disease type.

FIG. 3 is a table showing an example of genes clustered to the expression pattern of FIG. 2.

FIG. 4 is an example of a matching table showing the expression levels of single nucleotide polymorphisms (SNPs) in each patient, which is used in a method of discovering by copy-number variations (CNVs) according to a preferred embodiment of the present invention.

FIG. 5 is an example of a chromosome in which a CNV region selected from the expression levels of SNPs of FIG. 4 and a CNV region including effective genes are shown.

FIG. 6 is a graph showing an example of correlation analysis of the expression levels of CNV of FIG. 4 and a gene corresponding thereto.

FIG. 7 is an example of a matching table showing the expression levels of micro-RNAs (miRNA) in each patient, which is used in a method of discovering biomarkers by miRNAs according to a preferred embodiment of the present invention.

FIG. 8 is a graph showing an example of correlation analysis of the expression levels of the miRNA of FIG. 7 and a gene corresponding thereto.

FIG. 9 is an example of genes for each mechanism, which illustrates mechanism analysis which is used in a method of discovering biomarkers by mechanism analysis according to a preferred embodiment of the present invention.

FIG. 10 is a table showing an example of the expression levels of genes belonging to mechanism I of FIG. 9.

FIG. 11 is a table showing an example of the expression levels of genes belonging to mechanism II of FIG. 9.

FIG. 12 is a table showing an example of the expression levels of genes belonging to mechanism III of FIG. 9.

FIG. 13 is a graph showing an example of accuracy at each significant level for biomarkers discovered by a biomarker identification method according to a preferred embodiment of the present invention.

FIG. 14 is an optical photograph showing the results of discovering the subtypes of breast cancer using biomarkers identified by a biomarker identification method according to a preferred embodiment of the present invention.

FIG. 15 is a diagram showing a comparison between biomarkers according to a preferred embodiment of the present invention and biomarkers of other companies.

### DETAILED DESCRIPTION OF THE INVENTION

The present invention may be modified variously and may have various embodiments, particular examples of which will be illustrated in drawings and described in detail. However, it should be understood that the following exemplifying description is not intended to restrict the present invention to specific embodiments, and the present invention is meant to cover all modifications, equivalents and alternatives which are included in the spirit and scope of the present invention. In the following description, the detailed description of related known technology will be omitted when it may obscure the subject matter of the present invention.

The terms used in the present specification are used only to describe specific embodiments, and are not intended to limit the present invention. Singular expressions may include the meaning of plural expressions as long as there is no definite difference therebetween in the context. In the present application, it should be understood that terms such as “include” or “have”, are intended to indicate that proposed features, numbers, steps, operations, components, parts, or combinations thereof exist, and the probability of existence or addition of one or more other features, steps, operations, components, parts or combinations thereof is not excluded thereby.

Terms, such as “first” and “second,” can be used to describe various components, but the components are not limited by the terms. The terms are merely used to distinguish one component from another component.

A method for discovering biomarkers according to the present invention comprises the steps: matching the expression levels of genetic factors in persons, including a plurality of patients having a specific disease, for each of the persons; and comparing the expression expressions of the genetic factors and genes corresponding thereto by any one or more of cluster analysis and correlation analysis, thereby selecting some of the genetic factors.

The present invention is directed to a method for discovering biomarkers which are suitable for examining a specific disease on the basis of the expression levels of genetic factors in patients or persons including the patients. The genetic factor may be one or more selected from the group consisting of chromosomal genes, single nucleotide polymorphisms (SNPs), copy-number variations (CNVs) and micro-RNAs (miRNAs). In other words, the present invention is directed to a method for discovering highly accurate biomarkers by the use of genes of patients or persons, CNVs, miRNAs related to a specific disease, or a combination of two or more thereof.

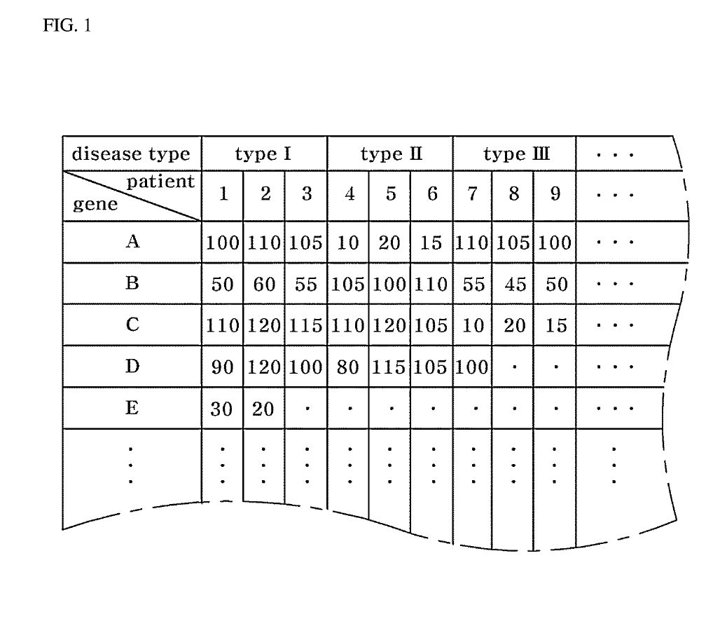

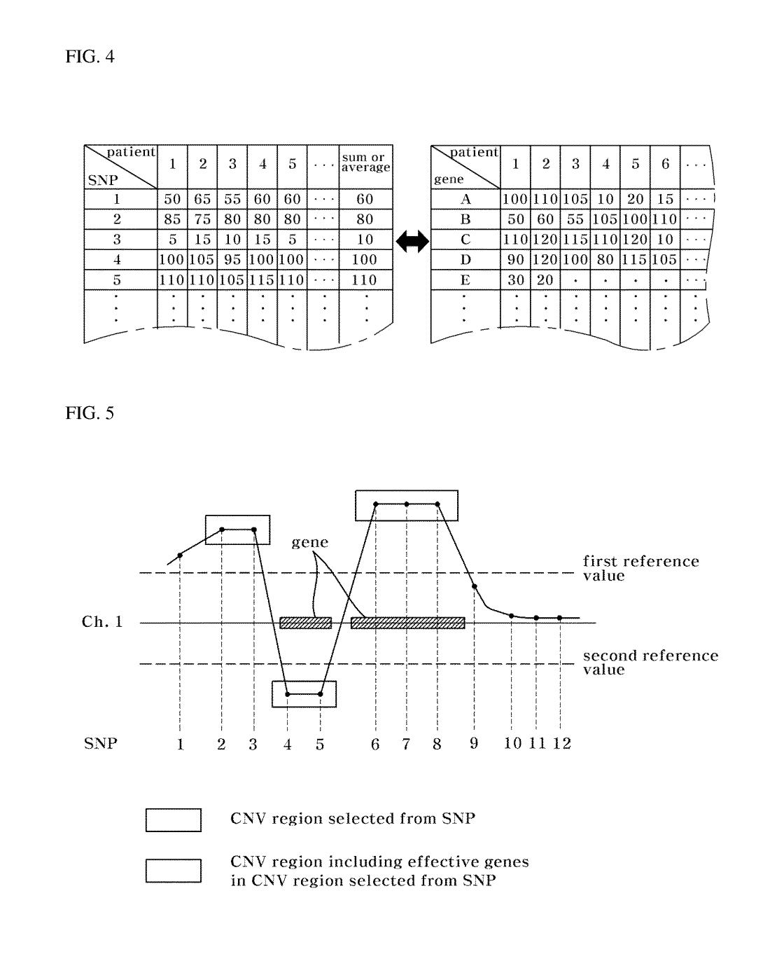

Specifically, in the method for indentifying biomarkers according to the present invention, a step of matching the expression levels in persons, including a plurality of patients having a specific disease, for each of the persons, is first performed. For example, genes and the expression levels thereof in a plurality of patients or persons can be made into database (see FIG. 1). In addition, it is also possible to match CNVs and the expression levels thereof in a plurality of patients or persons (see the left figure of FIG. 4) or to match miRNAs and the expression levels thereof (see the left figure of FIG. 7).

Then, in the present invention, the expression levels of the genetic factors and genes corresponding thereto are compared by any one or more of cluster analysis and correlation analysis, thereby selecting some of the genetic factors. This will be described in further detail.

Hereinafter, description will be made by way of example of breast cancer among diseases, but it will be obvious to those of ordinary skill in the art that the present invention is not limited thereto and can be applied to all diseases.

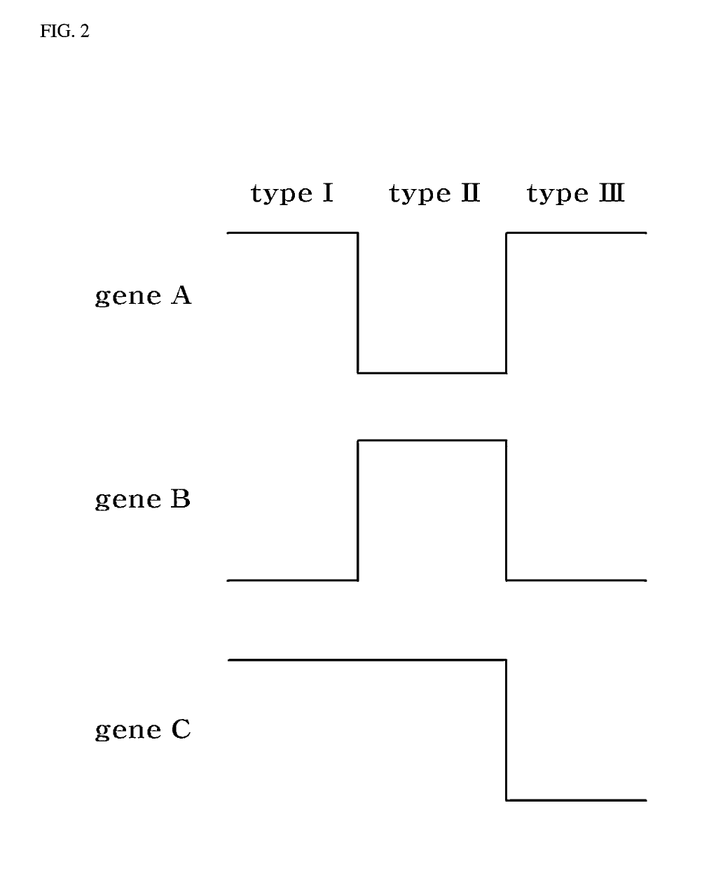

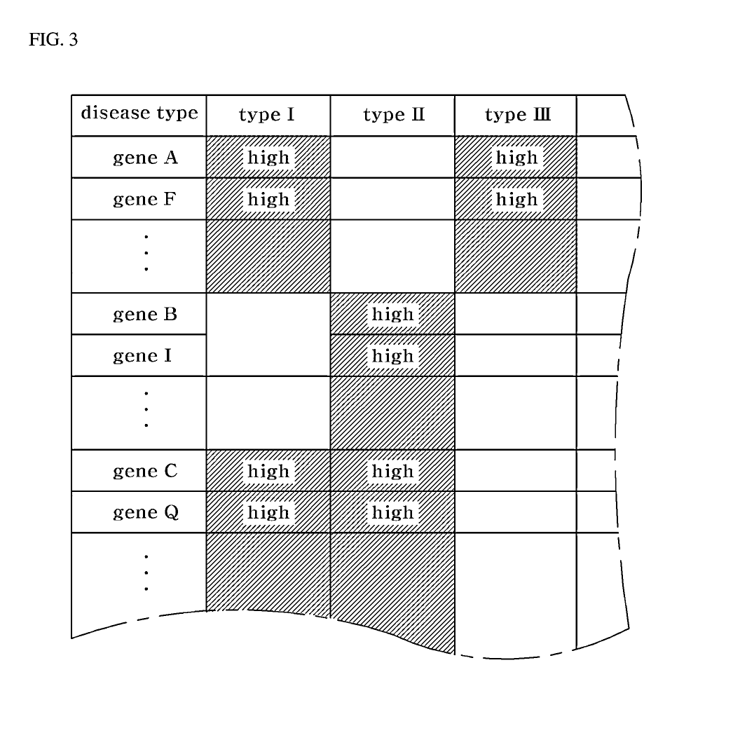

FIG. 1 is an example of a matching table showing the expression levels of genes in each patient, which is used in a method for discovering biomarkers for subtyping according to one embodiment of the present invention; FIG. 2 is an example of the expression level of each gene of FIG. 1 in patients according to each disease type; and FIG. 3 is a table showing an example of genes clustered according to the expression pattern of FIG. 2.

The method for discovering biomarkers for subtyping according to the present invention comprises the steps of: matching the expression levels of genes on the chromosome of in a plurality of patients having a specific disease for each of the patients, and selecting only information about specific disease-related genes from among the above genes; analyzing the expression patterns of the genes in the patients according to the type of the disease; and clustering the genes according to the expression pattern.

This invention is directed to a method of using the patient's genes as genetic factors and analyzing the expression levels of the genes, thereby identifying biomarkers. This invention makes it possible to discover biomarkers by which even the subtypes of a specific disease can be identified.

In the method for discovering biomarkers for subtyping according to the present invention, as shown in FIG. 1, a step of matching the expression levels of genes on the chromosome of a plurality of patients having a specific disease for each of the patients is first performed. That is, the expression levels of some or all genes in each patient are mapped. Herein, the patients may be classified according to the type of disease, and the order of the patients is not critical. Because such patient's genes also include genes which are not related with the specific disease, a step of selecting only information about specific disease-related genes among the above genes may then be performed. For example, if the number of genes of each patient is about 30,000, information on breast cancer-related genes is extracted. Selecting only information about specific disease-related genes as described above may be performed using information about genes known to be related to the specific disease. Based on 327 information obtained from patients, papers, patents, studies information and the like which are related to breast cancer, the present inventors selected 866 genes related to breast cancer. Herein, matching the expression levels of genes in each patient and selecting only information about specific disease-related genes among the genes may be performed in any order or simultaneously.

In the method for discovering biomarkers for subtyping according to the present invention, as shown in FIG. 2, a step of analyzing the expression levels of the genes in the patients according to the disease type is then performed. That is, the expression patterns of specific genes in the patients according to each disease type are analyzed, and in this analysis, the expression patterns of the genes in the patients according to each disease type can be divided into two or more levels. For example, as shown in FIG. 2, the expression patterns of each gene according to each disease type can be divided into high and low levels. In the present invention, the expression degree of each gene is not analyzed, but the expression pattern is analyzed as described above, and genes can be clustered according to the expression pattern.

In other words, in the method for discovering biomarkers for subtyping according to the present invention, a step of clustering genes according to the expression pattern as shown in FIG. 3 is subsequently performed. Genes showing the same expression pattern according to the type of disease are grouped. Herein, clustering genes according to the expression pattern is performed by selecting and clustering only genes having similar expression patterns, and genes that cannot be clustered due to different expression patterns are preferably excluded. In fact, the present inventors classified the 866 breast cancer-related genes into 4 categories according to the expression pattern, and the number of genes clustered in this manner was 646. As described above, the present invention is characterized in that clustered genes are selected as markers related to subtyping of a specific disease, and when the selected genes are used as biomarkers and compared with the expression patterns of the genes of interest in a patient, the disease of the patient can be predicted.

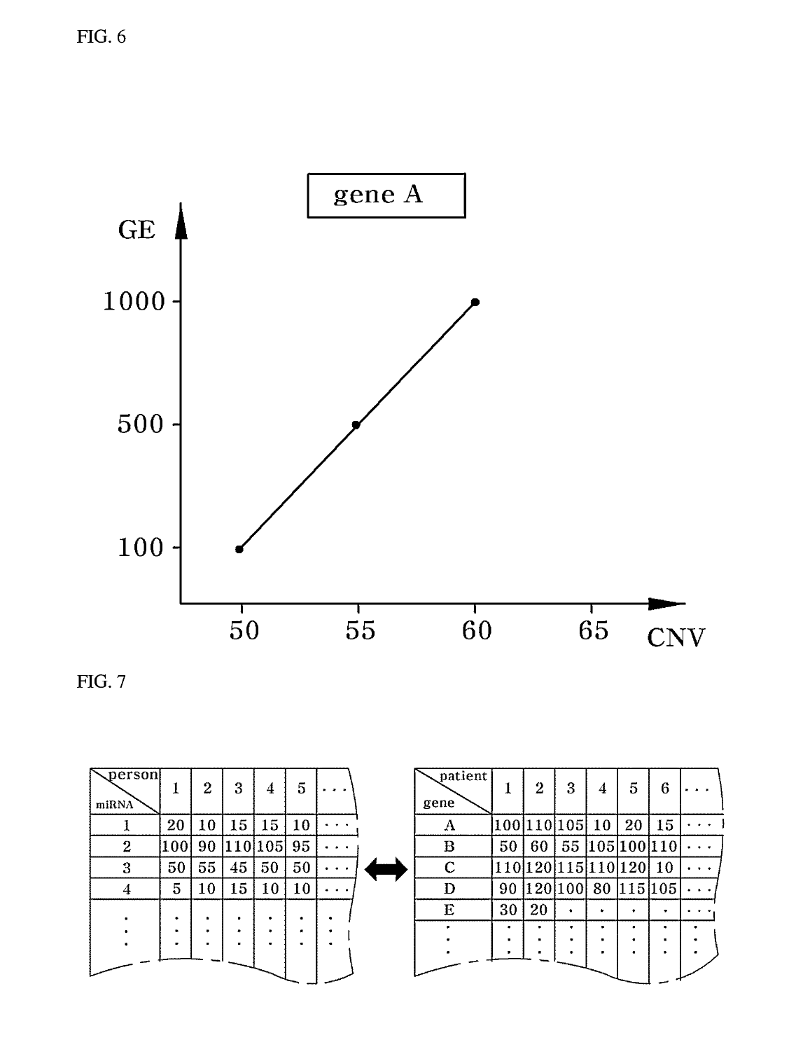

FIG. 4 is an example of a matching table showing the expression levels of single nucleotide polymorphisms (SNPs) in each patient, which is used in a method of discovering by copy-number variations (CNVs) according to a preferred embodiment of the present invention; FIG. 5 is an example of a chromosome in which a CNV region selected from the expression levels of SNPs of FIG. 4 and a CNV region including effective genes are shown; and FIG. 6 is a graph showing an example of correlation analysis of the expression levels of CNV of FIG. 4 and a gene corresponding thereto.

A method of indentifying biomarkers by copy-number variations (CNVs) according to the present invention comprises the steps of: matching the expression level of each of single nucleotide polymorphisms (SNPs) and genes on the chromosome of a plurality of patients having a specific disease for each of the patients; selecting a CNV region in which the SNP expression level is higher or lower than a specific reference value, and selecting CNVs present on effective genes at the location on the chromosome of the CHV region; and performing correlation analysis of the expression levels of the selected CNVs and genes corresponding thereto on the chromosome of the patients to select genes showing positive (+) correlation from among the above genes.

This invention is directed to a method of using SNPs and/or CNVs of patients as genetic factors and analyzing copy-number variations (CNVs) according to the expression levels of the genetic factors, thereby discovering biomarkers. This invention is based on the fact that specific disease-related SNPs exist and that the expression levels of specific genes including CNVs according to SNPs are directly proportional to the specific disease.

In the method of discovering biomarkers by copy-number variations (CNVs) according to the present invention, as shown in FIG. 4, a step of matching the expression levels of SNPs on the chromosome of a plurality of patients having a specific disease for each of the patients is first performed. Herein, CHVs selected from the SNPs may be CNVs of all the patients and may also be CNVs related to a specific disease among the CNVs. Such CNVs may include those which are not related to a specific disease. Thus, a process of selecting CNVs, which can be suitably used for analysis or assessment of disease, from among the CNVs, is required.

For this purpose, as shown in FIG. 5, the present invention comprises a step of selecting a CNV region in which the SNP expression level is higher or lower than a specific reference value, and selecting CNVs present on effective genes at the location on the chromosome of the CNV region. That is, because the CNVs according to the present invention are for patients having a specific disease, disease-related CNVs are selected according to the expression levels thereof, and in order to select CNVs having particular effects on gene expression from among such CNVs, CNVs present on sequences containing effective genetic information are selected according to the locations of CNVs. Herein, selecting the CNVs is preferably performed by selecting CNVs in which the SNP expression level is equal to or higher than a first reference value or equal to or lower than a second reference value, according to correlation of the expression levels of SNPs and genes corresponding thereto. For example, as shown in FIG. 5, the expression levels of SNPs present on the chromosome 1 (ch. 1) can differ from each other, and among them, CNVs present on sequences containing effective genetic information can be selected according to the locations of SNPs whose expression levels are higher or lower than the specific reference values.

Then, a step of performing correlation analysis of the expression levels of the selected CNVs and genes corresponding thereto on the chromosome of the patients (see the right figure of FIG. 4) to select genes showing positive (+) correlation is performed. For this purpose, the present invention further comprises information about the expression levels of genes on the chromosome of patients, and such information is information about the expression levels of genes in patients, which have a correlation with CNVs, and it may be the same as information about the expression levels of chromosomal genes used in the above method for discovering biomarkers for subtyping (see FIG. 1). The correlation analysis is performed in order to extract those related to gene expression among the above selected CNVs. That is, as the expression levels of CNVs obtained from the SNP expression increase, the expression levels of genes related thereto (genes in which the CNVs are located) increase, suggesting that CNVs and genes corresponding thereto have a high correlation with disease. On the contrary, if the expressions of CNVs and genes corresponding thereto have negative (−) correlation or have no special correlation, the CNVs and the genes corresponding thereto have a low correlation with disease.

In fact, the present inventors found 324 CNV regions from the SNP expression levels from about one million SNPs, and selected 327 genes according to the locations of the CNVs on the chromosome, and also selected 73 genes showing positive (+) correlation from the 327 selected genes. As described above, the present invention is characterized in that CNVs related to a specific disease are selected and specific genes related thereto are selected as markers. When the selected genes are used as biomarkers and compared with the expression patterns of the genes of interest in a patient, the disease of the patient can be predicted.

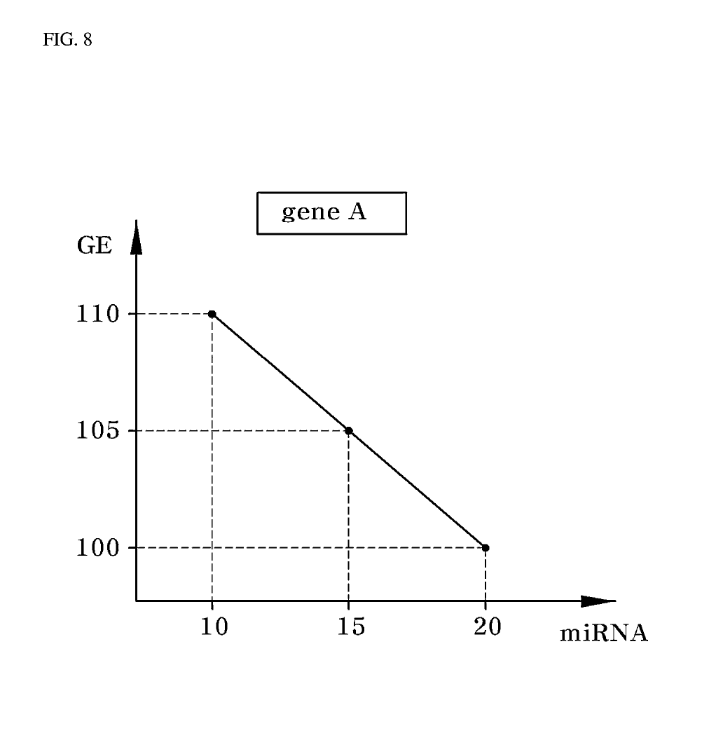

FIG. 7 is an example of a matching table showing the expression levels of micro-RNAs (miRNA) in each patient, which is used in a method of discovering biomarkers by miRNAs according to a preferred embodiment of the present invention; and FIG. 8 is a graph showing an example of correlation analysis of the expression levels of the miRNA of FIG. 7 and a gene corresponding thereto.

A method of discovering biomarkers by micro-RNAs (miRNAs) according to the present invention comprises the steps of matching the expression levels of miRNAs and genes in a plurality of patients having a specific disease for each of the patients; and performing correlation analysis of the expression levels of the miRNAs and genes corresponding thereto, and selecting genes showing negative (−) or positive (+) correlation, and selecting genes corresponding to specific disease-related miRNAs from among the selected genes.

This invention is a method of using patient's miRNAs as genetic factors and analyzing the expression levels thereof to identify biomarkers. Specific disease-related miRNAs exist and miRNAs act to inhibit the expressions of genes. Thus, this invention is based on a negative (−) correlation in which the expression levels of the miRNAs are inversely proportional to the expression levels of specific genes. In addition, because some miRNAs act to increase the expressions of genes, this invention is based on a positive (+) correlation in which the expression levels of the miRNAs are proportional to the expression levels of specific genes related thereto.

In the method of discovering biomarkers by micro-RNAs (miRNAs) according to the present invention, as shown in FIG. 7, a step of matching the expression level of each of miRNAs and genes in a plurality of persons, including patients, for each of the persons, is first performed. Herein, the miRNAs may be total miRNAs of persons and may also be specific disease-related miRNAs. Such miRNAs may also include those that are not related to a specific disease. Thus, a process of selecting miRNAs as biomarkers, which may be suitably used in analysis or assessment of disease, from among such miRNAs, is required.

For this purpose, in the present invention, a step of performing correlation analysis of the expression levels of the selected miRNAs and genes corresponding thereto (see the right figure of FIG. 7), and, for example, genes showing negative (−) correlation as shown in FIG. 8, and selecting genes corresponding to specific disease-related miRNAs from among the selected genes, is performed. That is, because the miRNAs according to the present invention are for all persons, including patients and normal persons, it is required to select disease-related miRNAs from among such miRNAs, and for this purpose, the specific disease-related miRNAs can be selected using miRNAs known to be related to the specific disease. At the same time, among such miRNAs, miRNAs having particular effects on gene expression are required to be selected, and for this purpose, correlation analysis is carried out in the present invention. For correlation analysis, the present invention further comprises information about the expression levels of genes on the chromosome of patients, and such information is information about the expression levels of genes in patients, which have no correlation with miRNAs, and it may be the same as information about the expression levels of chromosomal genes used in the above method for discovering biomarkers for subtyping (see FIG. 1). The correlation analysis is performed in order to extract those related to gene expression from among the above selected miRNAs. That is, as the expression levels of miRNAs increase, the expression levels of genes related thereto (genes in which the CNVs are located) become higher or lower than any reference value, suggesting that miRNAs and genes corresponding thereto have a high correlation with the disease. On the contrary, if the expression levels of miRNAs and genes corresponding thereto have a correlation within the reference value or have no special correlation, the miRNAs and the genes corresponding thereto have a low correlation with the disease.

In this invention, selecting genes corresponding to specific disease-related miRNAs from among the above genes may be performed in any order. For example, it may be performed before correlation analysis. Specifically, the method of discovering biomarkers by micro-RNAs according to the present invention may comprises the steps of: matching the expression level of each of micro-RNAs (miRNAs) and genes in persons, including a plurality of patients having a specific disease, for each of the persons; selecting genes corresponding to specific disease-related miRNAs from among the above genes; and performing correlation analysis of the expression levels of the specific disease-related miRNAs and genes corresponding thereto and selecting genes showing negative (−) or positive (+) correlation.

In fact, based on 1,265 information obtained from patients, papers, patents, studies information and the like which are related to breast cancer, the present inventors selected 38 miRNAs related to breast cancer and selected 246 genes from genes related to the 38 selected miRNAs by negative (−) or positive (+) correlation analysis. As described above, the present invention is characterized in that specific disease-related miRNAs are selected and specific genes related thereto are selected as markers. When the selected genes are used as biomarkers and compared with the expression patterns of the genes of interest in a patient, the disease of the patient can be predicted.

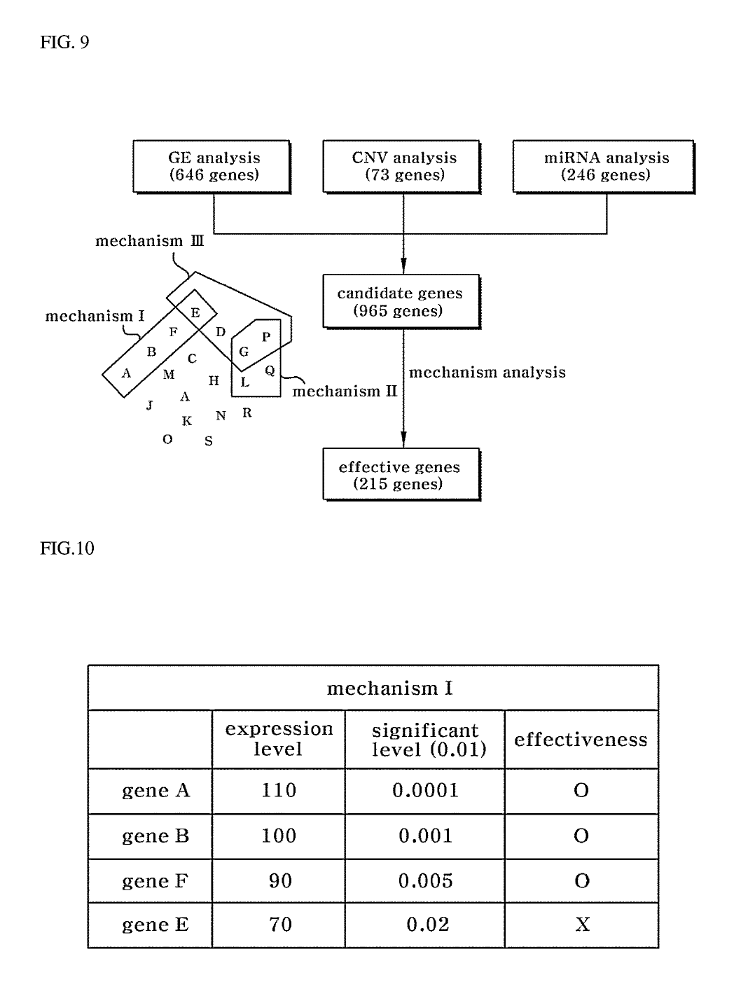

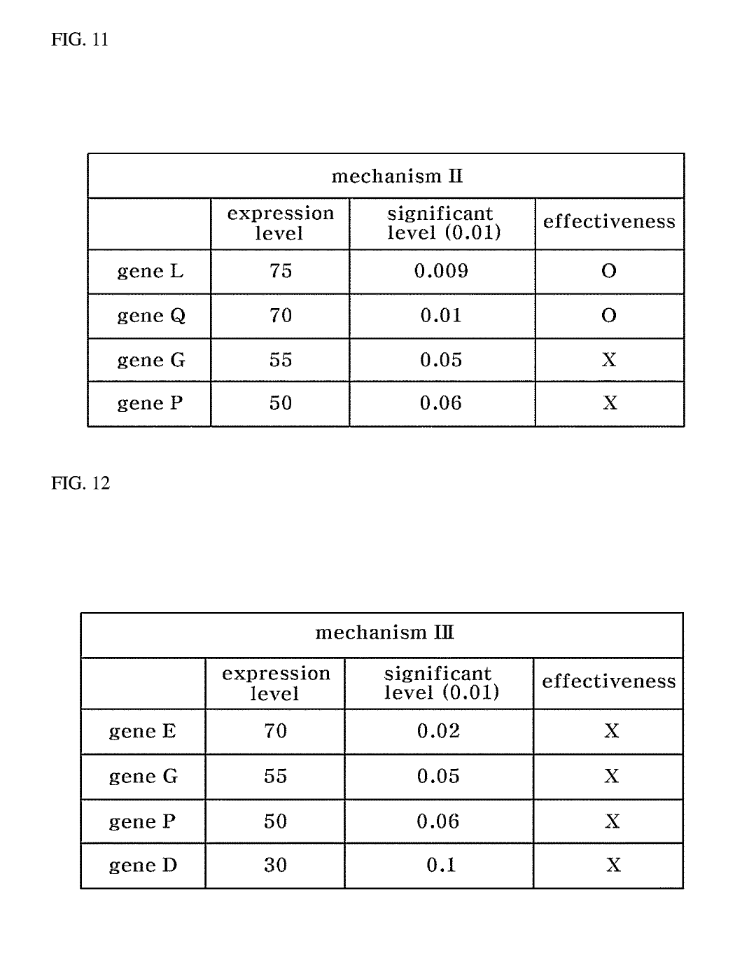

FIG. 9 is an example of genes for each mechanism, which illustrates mechanism analysis which is used in a method of discovering biomarkers by mechanism analysis according to a preferred embodiment of the present invention; FIG. 10 is a table showing an example of the expression levels of genes belonging to mechanism I of FIG. 9; FIG. 11 is a table showing an example of the expression levels of genes belonging to mechanism II of FIG. 9; FIG. 12 is a table showing an example of the expression levels of genes belonging to mechanism III of FIG. 9.

The method of discovering biomarkers by mechanism analysis according to the present invention comprises the steps of: classifying genes, belonging to a group of candidate genes suitable for use as biomarkers of a disease, as a group related to the action mechanism of a specific disease; and comparing the expression levels of the genes of the classified group in a plurality of patient groups and a normal person group, and selecting genes which are expressed more highly in the patient groups.

In this invention, candidate genes are grouped according to the relevance of molecular biological action or function, and biomarkers are selected according to the expressions of the genes of the group.

For this purpose, in the present invention, a step of classifying genes, belonging to a candidate gene group, as a group related to the action mechanism of a specific disease, is first performed. As used herein, the term “action mechanism of a specific disease” refers to the relevance of any one molecular biological action or function. For example, when genes A, B, E and F together perform a molecular biological function related to a specific disease, the genes A, B, E and 9 can be classified as one mechanism (or pathway or network) I group as shown in FIG. 9. This step may comprise a process of selecting a specific disease-related mechanism from a plurality of mechanisms, and this process may be performed by selecting a mechanism including genes showing high expression levels using the information about gene expression levels used in the above gene expression (GE) analysis. That is, classifying genes belonging to the candidate gene group as a group related to the action mechanism of a specific disease can be performed by comparing gene expression levels between a plurality of patient groups having a specific disease and a normal person group and selecting a disease action mechanism including genes, which are expressed more highly in the patient groups, as a group related to the mechanism of action of the specific disease.

After or simultaneously with or before the above step, a step of comparing the expression levels of the genes of the classified group in the plurality of patient groups having the specific disease and the normal person group and selecting genes which are expressed more highly in the patient groups is performed in the present invention. This step may be performed by T-test for the plurality of patient groups having the specific disease and the normal person group. Specifically, as shown in FIG. 10, when T-test (significant level: 0.01) is performed for genes belonging to mechanism I in the patient groups and the normal person group, genes A, B and F were within the significant level, and thus it appear that there is a significant difference between the patient groups and the normal group, suggesting that genes A, B and F can be effective biomarkers. In comparison with this, the significant level of gene E is higher than 0.01, and thus gene E cannot be an effective biomarker. According to this principle, in mechanism II of FIG. 11, only genes L and Q can be effective biomarker, and in mechanism III of FIG. 12, any gene cannot be an effective biomarker. Also, mechanism III cannot be classified as a group related to the mechanism of action of a specific disease.

As described above, according to T-test on the patient group and the normal person group, the step of classifying the genes as a group related to the mechanism of action of a specific disease and the step of selecting genes which are expressed more highly in the patient group can be performed at the same time.

Moreover, with respect to other characteristics of the present invention, the process of comparing the expression levels of the genes of the classified group and selecting genes which are expressed more highly in the patient group, T-test is first performed for the genes of the classified group which have high expression levels, and thus the genes which are expressed more highly in the patient groups are selected. For example, as shown in FIG. 12, T-test is first performed for gene E having the highest expression level among genes E, G, P and D, and when the result is confirmed to be the significant level (0.01), T-test for other genes G, P and D does not needed to be performed and the mechanisms and the genes belonging thereto appear to be unnecessary.

In addition, in the method of discovering biomarkers by mechanism analysis according to the present invention, the candidate gene group preferably includes genes obtained by the above-described biomarker identification methods. In this case, more highly accurate biomarkers can be selected using the method of discovering biomarkers by mechanism analysis together with the above-described biomarker identification method.

Furthermore, the candidate gene group more preferably includes genes obtained by the method for identification of biomarkers for subtyping, genes obtained by method of discovering biomarkers by copy-number variations (CNVs), and genes obtained by the method of discovering biomarkers by micro-RNAs (miRNAs). In this case, the highest accurate biomarkers can be selected using a combination of various biomarker discovery methods on patients and persons.

In fact, as shown in FIG. 9, the present inventors obtained 646 genes by the method for discovering biomarkers for subtyping, 73 genes by the method of discovering biomarkers by copy-number variations, and 246 genes by the method of discovering biomarkers by micro-RNAs, and then 965 candidate genes which did not overlap. In addition, the present inventors analyzed breast cancer-related mechanisms among 1,340 mechanisms, thereby finally selecting 215 genes.

The 215 selected genes are shown in Table 1 below.

TABLE 1

| | | | | Discovery |
|---|---|---|---|---|
| | No | Gene symbol | Gene function | type |
| 1 | 402 | Acacb | acetyl-Coenzyme A carboxylase beta | GE |
| 2 | 302 | ACADSB | acyl-Coenzyme A dehydrogenase, short/branched | GE |
| | | | chain | |
| 3 | 272 | agl | amylo-1,6-glucosidase, 4-alpha-glucanotransferase | GE |
| 4 | 461 | Ap1g1 | adaptor-related protein complex 1, gamma 1 | GE |
| | | | subunit | |
| 5 | 35 | APC | adenomatous polyposis coli | miRNA |
| 6 | 16 | APP | amyloid beta (A4) precursor protein | miRNA |
| 7 | 313 | aqp1 | aquaporin 1 (Colton blood group) | GE |
| 8 | 273 | AQP3 | aquaporin 3 (Gill blood group) | GE |
| 9 | 365 | Ar | androgen receptor | GE |
| 10 | 146 | Arf6 | ADP-ribosylation factor 6 | CNV |
| 11 | 289 | Atp7b | ATPase, Cu++ transporting, beta polypeptide | GE |
| 12 | 281 | AURKA | aurora kinase A; aurora kinase A pseudogene 1 | GE |
| 13 | 338 | AURKB | aurora kinase B | GE |
| 14 | 145 | Bad | BCL2-associated agonist of cell death | CNV |
| 15 | 39 | BCL2 | B-cell CLL/lymphoma 2 | miRNA |
| 16 | 12 | BDNF | brain-derived neurotrophic factor | miRNA |
| 17 | 224 | bhlhe40 | basic helix-loop-helix family, member e40 | GE |
| 18 | 238 | BIRC5 | baculoviral IAP repeat-containing 5 | GE |
| 19 | 345 | BUB1 | budding uninhibited by benzimidazoles 1 homolog | GE |
| | | | (yeast) | |
| 20 | 274 | BUB1B | budding uninhibited by benzimidazoles 1 homolog | GE |
| | | | beta (yeast) | |
| 21 | 423 | C3 | similar to Complement C3 precursor; complement | GE |
| | | | component 3; hypothetical protein LOC100133511 | |
| 22 | 400 | capn3 | calpain 3, (p94) | GE |
| 23 | 262 | cav1 | caveolin 1, caveolae protein, 22 kDa | GE |
| 24 | 268 | CCNA2 | cyclin A2 | GE |
| 25 | 405 | CCNB1 | cyclin B1 | GE |
| 26 | 254 | CCNB2 | cyclin B2 | GE |
| 27 | 319 | CCND1 | cyclin D1 | GE |
| 28 | 126 | CCNE1 | cyclin E1 | miRNA |
| 29 | 299 | Ccne2 | cyclin E2 | GE |
| 30 | 351 | ccno | cyclin O | GE |
| 31 | 211 | cct5 | chaperonin containing TCP1, subunit 5 (epsilon) | GE |
| 32 | 310 | CD36 | CD36 molecule (thrombospondin receptor) | GE |
| 33 | 66 | CDC14B | CDC14 cell division cycle 14 homolog B (S. cerevisiae) | miRNA |
| 34 | 258 | cdc20 | cell division cycle 20 homolog (S. cerevisiae) | GE |
| 35 | 209 | CDC25A | cell division cycle 25 homolog A (S. pombe) | GE |
| 36 | 53 | Cdc42 | cell division cycle 42 (GTP binding protein, | miRNA |
| | | | 25 kDa); cell division cycle 42 pseudogene 2 | |
| 37 | 399 | CDC42BPA | CDC42 binding protein kinase alpha (DMPK-like) | GE |
| 38 | 54 | CDC42P2 | cell division cycle 42 (GTP binding protein, | miRNA |
| | | | 25 kDa); cell division cycle 42 pseudogene 2 | |
| 39 | 277 | cdc6 | cell division cycle 6 homolog (S. cerevisiae) | GE |
| 40 | 453 | cdca7 | cell division cycle associated 7 | GE |
| 41 | 440 | CDCA8 | cell division cycle associated 8 | GE |
| 42 | 222 | CDH1 | cadherin 1, type 1, E-cadherin (epithelial) | GE |
| 43 | 263 | Cdk1 | cell division cycle 2, G1 to S and G2 to M | GE |
| 44 | 153 | CDK11A | similar to cell division cycle 2-like 1 (PITSLRE | CNV |
| | | | proteins); cell division cycle 2-like 1 (PITSLRE | |
| | | | proteins); cell division cycle 2-like 2 (PITSLRE | |
| | | | proteins) | |
| 45 | 154 | Cdk11b | similar to cell division cycle 2-like 1 (PITSLRE | CNV |
| | | | proteins); cell division cycle 2-like 1 (PITSLRE | |
| | | | proteins); cell division cycle 2-like 2 (PITSLRE | |
| | | | proteins) | |
| 46 | 74 | CEBPB | CCAAT/enhancer binding protein (C/EBP), beta | miRNA |
| 47 | 386 | cebpd | CCAAT/enhancer binding protein (C/EBP), delta | GE |
| 48 | 297 | CENPA | centromere protein A | GE |
| 49 | 300 | CENPE | centromere protein E, 312 kDa | GE |
| 50 | 315 | CENPF | centromere protein F, 350/400ka (mitosin) | GE |
| 51 | 431 | CENPN | centromere protein N | GE |
| 52 | 243 | CFB | complement factor B | GE |
| 53 | 439 | CLTC | clathrin, heavy chain (Hc) | GE |
| 54 | 212 | CP | ceruloplasmin (ferroxidase) | GE |
| 55 | 148 | CTDSP2 | similar to hCG2013701; CTD (carboxy-terminal | CNV |
| | | | domain, RNA polymerase II, polypeptide A) small | |
| | | | phosphatase 2 | |
| 56 | 5 | CTNNB1 | catenin (cadherin-associated protein), beta 1, 88 kDa | miRNA |
| 57 | 306 | Cx3cr1 | chemokine (C—X3—C motif) receptor 1 | GE |
| 58 | 286 | CXCL1 | chemokine (C—X—C motif) ligand 1 (melanoma | GE |
| | | | growth stimulating activity, alpha) | |
| 59 | 425 | cybrd1 | cytochrome b reductase 1 | GE |
| 60 | 311 | CYP2B6 | cytochrome P450, family 2, subfamily B, | GE |
| | | | polypeptide 6 | |
| 61 | 93 | dcaf7 | WD repeat domain 68 | miRNA |
| 62 | 266 | DCK | deoxycytidine kinase | GE |
| 63 | 418 | DST | dystonin | GE |
| 64 | 179 | E2F1 | E2F transcription factor 1 | miRNA, |
| | | | | GE |
| 65 | 441 | E2f5 | E2F transcription factor 5, p130-binding | GE |
| 66 | 234 | egfr | epidermal growth factor receptor (erythroblastic | GE |
| | | | leukemia viral (v-erb-b) oncogene homolog, avian) | |
| 67 | 201 | Erbb2 | v-erb-b2 erythroblastic leukemia viral oncogene | CNV, GE |
| | | | homolog 2, neuro/glioblastoma derived oncogene | |
| | | | homolog (avian) | |
| 68 | 301 | Esr1 | estrogen receptor 1 | GE |
| 69 | 208 | ETS1 | v-ets erythroblastosis virus E26 oncogene homolog | GE |
| | | | 1 (avian) | |
| 70 | 167 | F11r | F11 receptor | CNV |
| 71 | 48 | F2 | coagulation factor II (thrombin) | miRNA |
| 72 | 499 | FABP4 | fatty acid binding protein 4, adipocyte | GE |
| 73 | 250 | Fadd | Fas (TNFRSF6)-associated via death domain | GE |
| 74 | 292 | FEN1 | flap structure-specific endonuclease 1 | GE |
| 75 | 395 | Fermt2 | fermitin family homolog 2 (Drosophila) | GE |
| 76 | 314 | Fgfr1 | fibroblast growth factor receptor 1 | GE |
| 77 | 287 | Fgfr4 | fibroblast growth factor receptor 4 | GE |
| 78 | 432 | FGG | fibrinogen gamma chain | GE |
| 79 | 464 | FLT1 | fms-related tyrosine kinase 1 (vascular endothelial | GE |
| | | | growth factor/vascular permeability factor receptor) | |
| 80 | 213 | fn1 | fibronectin 1 | GE |
| 81 | 305 | Gas2 | growth arrest-specific 2 | GE |
| 82 | 340 | GATA3 | GATA binding protein 3 | GE |
| 83 | 303 | gfra1 | GDNF family receptor alpha 1 | GE |
| 84 | 502 | GMPS | guanine monphosphate synthetase | GE |
| 85 | 50 | Gna13 | guanine nucleotide binding protein (G protein), | miRNA |
| | | | alpha 13 | |
| 86 | 394 | Gnas | GNAS complex locus | GE |
| 87 | 10 | gpD1 | glycerol-3-phosphate dehydrogenase 1 (soluble) | miRNA |
| 88 | 356 | Grb7 | growth factor receptor-bound protein 7 | GE |
| 89 | 27 | GTF2H1 | general transcription factor IIH, polypeptide 1, | miRNA |
| | | | 62 kDa | |
| 90 | 4 | HDAC4 | histone deacetylase 4 | miRNA |
| 91 | 433 | Hhat | hedgehog acyltransferase | GE |
| 92 | 426 | Hjurp | Holliday junction recognition protein | GE |
| 93 | 348 | HOXB13 | homeobox B13 | GE |
| 94 | 130 | HSD17B12 | hydroxysteroid (17-beta) dehydrogenase 12 | miRNA |
| 95 | 332 | id4 | inhibitor of DNA binding 4, dominant negative | GE |
| | | | helix-loop-helix protein | |
| 96 | 228 | Ifitm1 | interferon induced transmembrane protein 1 (9-27) | GE |
| 97 | 244 | IGF2 | insulin-like growth factor 2 (somatomedin A); | GE |
| | | | insulin; INS-IGF2 readthrough transcript | |
| 98 | 334 | IKBKB | inhibitor of kappa light polypeptide gene enhancer | GE |
| | | | in B-cells, kinase beta | |
| 99 | 309 | IL18 | interleukin 18 (interferon-gamma-inducing factor) | GE |
| 100 | 295 | IL6ST | interleukin 6 signal transducer (gp130, oncostatin | GE |
| | | | M receptor) | |
| 101 | 245 | INS | insulin-like growth factor 2 (somatomedin A); | GE |
| | | | insulin; INS-IGF2 readthrough transcript | |
| 102 | 182 | IRS1 | insulin receptor substrate 1 | miRNA, |
| | | | | GE |
| 103 | 60 | ITCH | itchy E3 ubiquitin protein ligase homolog (mouse) | miRNA |
| 104 | 298 | ITGA2 | integrin, alpha 2 (CD49B, alpha 2 subunit of VLA- | GE |
| | | | 2 receptor) | |
| 105 | 346 | ITGA7 | integrin, alpha 7 | GE |
| 106 | 21 | Jun | jun oncogene | miRNA |
| 107 | 220 | JUP | junction plakoglobin | GE |
| 108 | 285 | KIF11 | kinesin family member 11 | GE |
| 109 | 430 | KIF15 | kinesin family member 15 | GE |
| 110 | 427 | kif20a | kinesin family member 20A | GE |
| 111 | 291 | KIF23 | kinesin family member 23 | GE |
| 112 | 337 | KIF2C | kinesin family member 2C | GE |
| 113 | 434 | Klf4 | Kruppel-like factor 4 (gut) | GE |
| 114 | 221 | KPNA2 | karyopherin alpha 2 (RAG cohort 1, importin alpha | GE |
| | | | 1); karyopherin alpha-2 subunit like | |
| 115 | 336 | Krt14 | keratin 14 | GE |
| 116 | 227 | KRT18 | keratin 18; keratin 18 pseudogene 26; keratin 18 | GE |
| | | | pseudogene 19 | |
| 117 | 233 | KRT5 | keratin 5 | GE |
| 118 | 323 | krt8 | keratin 8 pseudogene 9; similar to keratin 8; keratin 8 | GE |
| 119 | 352 | LAMA5 | laminin, alpha 5 | GE |
| 120 | 375 | lbp | lipopolysaccharide binding protein | GE |
| 121 | 304 | LRP2 | low density lipoprotein-related protein 2 | GE |
| 122 | 519 | lzts1 | leucine zipper, putative tumor suppressor 1 | GE |
| 123 | 207 | Mad2l1 | MAD2 mitotic arrest deficient-like 1 (yeast) | GE |
| 124 | 283 | MAOA | monoamine oxidase A | GE |
| 125 | 516 | MAOB | monoamine oxidase B | GE |
| 126 | 384 | MAP1B | microtubule-associated protein 1B | GE |
| 127 | 163 | MAP3K1 | mitogen-activated protein kinase 1 | CNV |
| 128 | 275 | mapt | microtubule-associated protein tau | GE |
| 129 | 210 | mccc2 | methylcrotonoyl-Coenzyme A carboxylase 2 (beta) | GE |
| 130 | 124 | mcl1 | myeloid cell leukemia sequence 1 (BCL2-related) | miRNA |
| 131 | 436 | Mcm10 | minichromosome maintenance complex | GE |
| | | | component 10 | |
| 132 | 240 | mcm2 | minichromosome maintenance complex | GE |
| | | | component 2 | |
| 133 | 380 | MCM4 | minichromosome maintenance complex | GE |
| | | | component 4 | |
| 134 | 422 | mdm2 | Mdm2 p53 binding protein homolog (mouse) | GE |
| 135 | 269 | med1 | mediator complex subunit 1 | GE |
| 136 | 390 | MED24 | mediator complex subunit 24 | GE |
| 137 | 34 | MET | met proto-oncogene (hepatocyte growth factor | miRNA |
| | | | receptor) | |
| 138 | 363 | MGLL | monoglyceride lipase | GE |
| 139 | 428 | MLF1IP | MLF1 interacting protein | GE |
| 140 | 276 | Mmp9 | matrix metallopeptidase 9 (gelatinase B, 92 kDa | GE |
| | | | gelatinase, 92 kDa type IV collagenase) | |
| 141 | 507 | mtss1 | metastasis suppressor 1 | GE |
| 142 | 9 | myb | v-myb myeloblastosis viral oncogene homolog | miRNA |
| | | | (avian) | |
| 143 | 231 | MYBL2 | v-myb myeloblastosis viral oncogene homolog | GE |
| | | | (avian)-like 2 | |
| 144 | 178 | MYC | v-myc myelocytomatosis viral oncogene homolog | CNV |
| | | | (avian) | |
| 145 | 265 | myo6 | myosin VI | GE |
| 146 | 282 | NDC80 | NDC80 homolog, kinetochore complex component | GE |
| | | | (S. cerevisiae) | |
| 147 | 216 | ndrg1 | N-myc downstream regulated 1 | GE |
| 148 | 454 | NFIA | nuclear factor I/A | GE |
| 149 | 330 | NFIB | nuclear factor I/B | GE |
| 150 | 471 | nfix | nuclear factor I/X (CCAAT-binding transcription | GE |
| | | | factor) | |
| 151 | 307 | Nmu | neuromedin U | GE |
| 152 | 2 | NT5E | 5′-nucleotidase, ecto (CD73) | miRNA |
| 153 | 392 | Oip5 | Opa interacting protein 5 | GE |
| 154 | 429 | ORC6L | origin recognition complex, subunit 6 like (yeast) | GE |
| 155 | 215 | Pak2 | p21 protein (Cdc42/Rac)-activated kinase 2 | GE |
| 156 | 326 | PEG3 | paternally expressed 3; PEG3 antisense RNA (non- | GE |
| | | | protein coding); zinc finger, imprinted 2 | |
| 157 | 214 | PGK1 | phosphoglycerate kinase 1 | GE |
| 158 | 31 | Phkb | phosphorylase kinase, beta | miRNA |
| 159 | 424 | Pigt | phosphatidylinositol glycan anchor biosynthesis, | GE |
| | | | class T | |
| 160 | 520 | PIGV | phosphatidylinositol glycan anchor biosynthesis, | GE |
| | | | class V | |
| 161 | 150 | PIK3CA | phosphoinositide-3-kinase, catalytic, alpha | CNV |
| | | | polypeptide | |
| 162 | 71 | Pik3r1 | phosphoinositide-3-kinase, regulatory subunit 1 | miRNA |
| | | | (alpha) | |
| 163 | 241 | PLK1 | polo-like kinase 1 (Drosophila) | GE |
| 164 | 11 | Plxnd1 | plexin D1 | miRNA |
| 165 | 25 | pnp | nucleoside phosphorylase | miRNA |
| 166 | 29 | POLR2K | polymerase (RNA) II (DNA directed) polypeptide | miRNA |
| | | | K, 7.0 kDa | |
| 167 | 46 | POM121 | POM121 membrane glycoprotein (rat) | miRNA |
| 168 | 317 | PPARG | peroxisome proliferator-activated receptor gamma | GE |
| 169 | 149 | PPP6C | protein phosphatase 6, catalytic subunit | CNV |
| 170 | 45 | PRIM1 | primase, DNA, polypeptide 1 (49 kDa) | miRNA |
| 171 | 255 | PRKACB | protein kinase, cAMP-dependent, catalytic, beta | GE |
| 172 | 58 | PRKCI | protein kinase C, iota | miRNA |
| 173 | 42 | pten | phosphatase and tensin homolog; phosphatase and | miRNA |
| | | | tensin homolog pseudogene 1 | |
| 174 | 271 | PTTG1 | pituitary tumor-transforming 1; pituitary tumor- | GE |
| | | | transforming 2 | |
| 175 | 105 | Rab23 | RAB23, member RAS oncogene family | miRNA |
| 176 | 446 | racgap1 | Rac GTPase activating protein 1 pseudogene; Rac | GE |
| | | | GTPase activating protein 1 | |
| 177 | 67 | RB1 | retinoblastoma 1 | miRNA |
| 178 | 142 | Rbl1 | retinoblastoma-like 1 (p107) | CNV |
| 179 | 125 | rheb | Ras homolog enriched in brain | miRNA |
| 180 | 347 | rrm2 | ribonucleotide reductase M2 polypeptide | GE |
| 181 | 166 | rsf1 | remodeling and spacing factor 1 | CNV |
| 182 | 260 | S100A8 | S100 calcium binding protein A8 | GE |
| 183 | 235 | Sfrp1 | secreted frizzled-related protein 1 | GE |
| 184 | 15 | SFRS9 | splicing factor, arginine/serine-rich 9 | miRNA |
| 185 | 75 | slc30a1 | solute carrier family 30 (zinc transporter), member 1 | miRNA |
| 186 | 33 | SLC35A1 | solute carrier family 35 (CMP-sialic acid | miRNA |
| | | | transporter), member A1 | |
| 187 | 451 | SLC40A1 | solute carrier family 40 (iron-regulated transporter), | GE |
| | | | member 1 | |
| 188 | 280 | slc5a6 | solute carrier family 5 (sodium-dependent vitamin | GE |
| | | | transporter), member 6 | |
| 189 | 226 | SLC7A5 | solute carrier family 7 (cationic amino acid | GE |
| | | | transporter, y+ system), member 5 | |
| 190 | 257 | SLC7A8 | solute carrier family 7 (cationic amino acid | GE |
| | | | transporter, y+ system), member 8 | |
| 191 | 407 | Smarce1 | SWI/SNF related, matrix associated, actin | GE |
| | | | dependent regulator of chromatin, subfamily e, | |
| | | | member 1 | |
| 192 | 230 | SMC4 | structural maintenance of chromosomes 4 | GE |
| 193 | 417 | SNRPN | small nuclear ribonucleoprotein polypeptide N; | GE |
| | | | SNRPN upstream reading frame | |
| 194 | 219 | STAT1 | signal transducer and activator of transcription 1, | GE |
| | | | 91 kDa | |
| 195 | 308 | STAT4 | signal transducer and activator of transcription 4 | GE |
| 196 | 38 | tbca | tubulin folding cofactor A | miRNA |
| 197 | 288 | Tff3 | trefoil factor 3 (intestinal) | GE |
| 198 | 312 | TFRC | transferrin receptor (p90, CD71) | GE |
| 199 | 349 | TGFB2 | transforming growth factor, beta 2 | GE |
| 200 | 55 | Tgfbr2 | transforming growth factor, beta receptor II | miRNA |
| | | | (70/80 kDa) | |
| 201 | 90 | Th1l | TH1-like (Drosophila) | miRNA |
| 202 | 205 | tk1 | thymidine kinase 1, soluble | GE |
| 203 | 1 | TNFRSF10A | tumor necrosis factor receptor superfamily, | miRNA |
| | | | member 10a | |
| 204 | 252 | TNFSF10 | tumor necrosis factor (ligand) superfamily, member | GE |
| | | | 10 | |
| 205 | 232 | tp53 | tumor protein p53 | GE |
| 206 | 259 | TRAF4 | TNF receptor-associated factor 4 | GE |
| 207 | 18 | TRAM1 | translocation associated membrane protein 1 | miRNA |
| 208 | 8 | TXNRD1 | thioredoxin reductase 1; hypothetical | miRNA |
| | | | LOC100130902 | |
| 209 | 206 | Tyms | thymidylate synthetase | GE |
| 210 | 261 | UBE2C | ubiquitin-conjugating enzyme E2C | GE |
| 211 | 47 | UGP2 | UDP-glucose pyrophosphorylase 2 | miRNA |
| 212 | 40 | Vcam1 | vascular cell adhesion molecule 1 | miRNA |
| 213 | 6 | VIM | vimentin | miRNA |
| 214 | 217 | YWHAZ | tyrosine 3-monooxygenase/tryptophan 5- | GE |
| | | | monooxygenase activation protein, zeta | |
| | | | polypeptide | |
| 215 | 279 | ZWINT | ZW10 interactor | GE |

In Table 1 above, “No.” means the original number of genes, and “Discovery type” means a method used for discovery of the relevant gene.

Meanwhile, another embodiment of the present invention is directed to breast cancer-related biomarkers, including the genes shown in Table 1 above.

Also, the present invention may be directed to biomarkers, which include the genes shown in Table 1 above and allow the identification of the subtypes of breast cancer.

In addition, the present invention may be directed to a breast cancer test kit comprising: a microarray comprising probes corresponding to the genes shown in Table 1 above; and an optical measurement device for measuring changes in the expression of the genes.

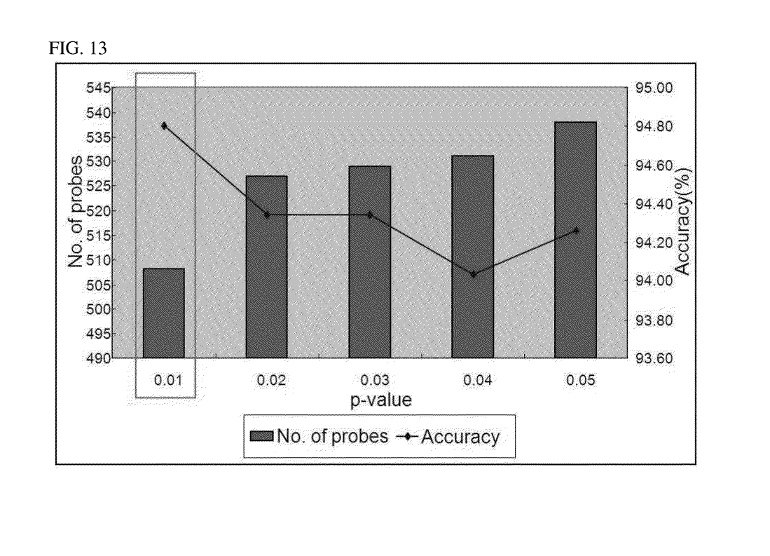

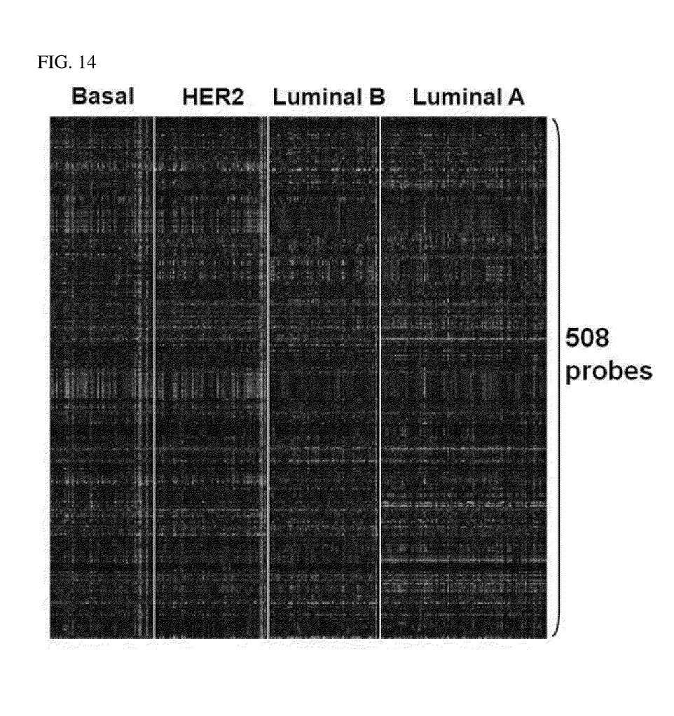

FIG. 13 is a graph showing an example of accuracy at each significant level for biomarkers indentified by a biomarker identification method according to a preferred to embodiment of the present invention. The present inventors constructed 508 probes corresponding to the 215 finally selected genes and performed T-test at varying significant levels of 0,01-0.05. As a result, at a significant level of 0.01, an accuracy of 94.8% was reached.

FIG. 14 is an optical photograph showing the results of identifying the subtypes of breast cancer using biomarkers identified by a biomarker identification method according to a preferred embodiment of the present invention. As can be seen therein, 508 probes showed optical properties different between 4 types of breast cancer, suggesting that these probes allow identification of the type of breast cancer.

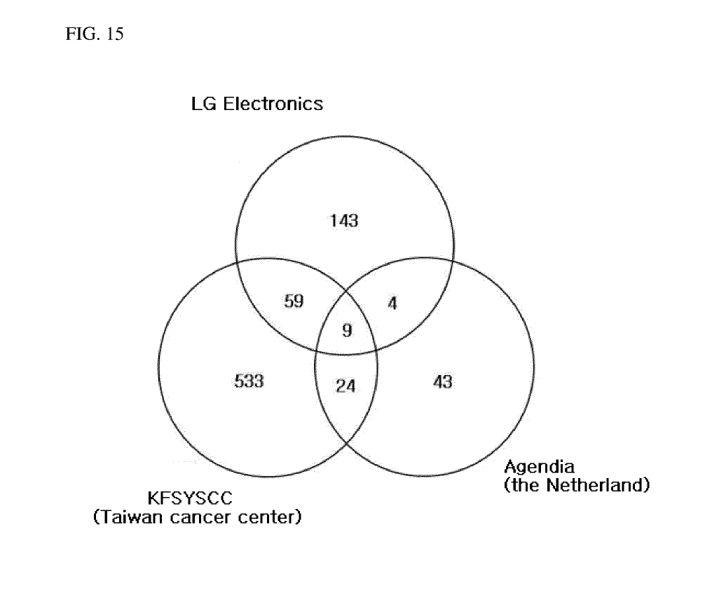

The biomarkers according to the present invention were compared with biomarkers of other companies, and the results of the comparison are shown in Table 2 below and FIG. 15. As can be seen in FIG, 15, the biomarkers according to the present invention partially overlap with the biomarkers of other companies, but the number of different biomarkers reaches 143.

TABLE 2

| | Number of | Number of | |
|---|---|---|---|
| Company name | genes | probes | Remarks |
| LG Electronics Co., Ltd. | 215 | 508 | GE: 346¹⁾ |
| | | | CNV: 47 |
| | | | miRNA: 162 |
| the Koo Foundation Sun | 625 | 783 | GE: 783²⁾ |
| Yat-Sen Cancer Center | | | |
| Center(KFSYSCC; Taiwan | | | |
| cancer center) | | | |
| Agendia | 80 | 219 | GE: 219²⁾ |
| (the Netherlands) | | | |

¹⁾Partial overlap between probes.
²⁾only GE data were used in KFSYSCC and Agendia

In addition, the accuracies of the biomarkers of the present invention and the biomarkers of KFSYSCC (Taiwan) were comparatively analyzed according to 4 types of breast cancer. The results of the analysis are shown in Table 3 (KFSYSCC (783 probes, 625 genes)) and Table 4 (LG Electronics (508 probes, 215 genes)).

TABLE 3

| Type | Sensitivity | Specificity | Total accuracy (%) |
|---|---|---|---|
| Basal | 0.98 | 0.97 | 87.80 |
| HER2 | 0.85 | 0.95 | |
| Luminal B | 0.53 | 0.95 | |
| Luminal A | 0.43 | 0.89 | |

TABLE 4

| Type | Sensitivity | Specificity | Total accuracy (%) |
|---|---|---|---|
| Basal | 0.98 | 0.96 | 89.80 |
| HER2 | 0.80 | 0.95 | |
| Luminal B | 0.52 | 0.94 | |
| Luminal A | 0.89 | 0.85 | |

As can be seen in Tables 3 and 4 above, a comparative test was performed using a total of 250 samples and, as a result, the inventive multiple biomarkers consisting of a relatively small number of genes showed a subtyping accuracy higher than KFSYSCC (Taiwan Cancer Center).

Also, the accuracies of the biomarkers of the present invention and the biomarkers of Agendia were comparatively analyzed according to 3 types of breast cancer. The results of the analysis are shown in Table 5 (Agendia (219 probes, 80 genes)) and Table 6 (LG Electronics (508 probes, 215 genes)).

TABLE 5

| Type | Sensitivity | Specificity | Total accuracy (%) |
|---|---|---|---|
| Basal | 0.98 | 0.95 | 88.50 |
| HER2 | 0.85 | 0.94 | |
| Luminal | 0.59 | 0.95 | |

TABLE 6

| Type | Sensitivity | Specificity | Total accuracy (%) |
|---|---|---|---|
| Basal | 0.98 | 0.96 | 94.13 |
| HER2 | 0.80 | 0.95 | |
| Luminal | 0.91 | 0.95 | |

As can be seen in Tables 5 and 6, a comparative test was performed using a total of 250 samples and, as a result, the multiple biomarkers of the present invention showed uniform accuracy for each subtype, but the multiple biomarkers of Agendia showed significantly low accuracy in luminal type prediction.

As described above, according to the present invention, highly accurate biomarkers for a specific disease can be identified in a simple and easy manner by comparing the expression levels of genetic factors and genes corresponding thereto by any one or more of cluster analysis and correlation analysis.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for discovering biomarkers, comprising the steps of:
matching the expression levels of genetic factors in persons, including a plurality of patients having a specific disease, for each of the persons; and
comparing the expression levels of the genetic factors and genes corresponding thereto by any one or more of cluster analysis and correlation analysis to select some of the genetic factors.

2. The method of claim 1, wherein the genetic factor is one or more selected from the group consisting of chromosomal genes, single nucleotide polymorphisms (SNPs), copy-number variations (CNVs) and micro-RNAs (miRNAs).

3. The method of claim 1, wherein matching the expression levels of the genetic factors for each of the persons is performed by matching the expression levels of genes on the chromosome of the plurality of patients having the specific disease for each of the patients, and the analysis of any one or more comprises the steps of selecting information about genes related to the specific disease from among the genes; analyzing the expression patterns of the selected genes in the patients according to the type of the disease; and clustering the genes according to the expression patterns.

4. The method of claim 3, wherein selecting only the information about genes related to the specific disease from among the genes is performed by selecting only information about genes known to be related to the specific disease.

5. The method of claim 3, wherein analyzing the expression patterns of the selected genes in the patients according to the type of the disease is performed by dividing the expression patterns of the genes in the patients according to the disease type into two or more levels.

6. The method of claim 3, wherein the step of clustering the genes according to the expression patterns comprises a step of selecting only genes which may be clustered according to the expression patterns, and selecting the selected genes as markers related to subtyping of the specific disease.

7. The method of claim 1, wherein matching the expression levels of the genetic factors for each of the persons is performed by matching the expression levels of single nucleotide polymorphisms (SNPs) and genes on the chromosomal of the plurality of patients having the specific disease for each of the patients, and the analysis of any one of more comprises the steps of: selecting a copy-number variation (CNV) region in which the expression levels of the SNPs are higher or lower than a specific reference value, and selecting CNVs present on effective genes at the location on the chromosome of the CNV region; and performing correlation analysis of the expression levels of the selected CNVs and genes corresponding thereto on the chromosomes of the patients to select genes showing positive (+) correlation.

8. The method of claim 7, wherein the effective genes are sequences containing genetic information.

9. The method of claim 7, wherein selecting the CNVs is performed by selecting a CNV region in which the expression levels of the SNPs are higher than a first reference value or lower than a second reference value, and selecting CNVs present on sequences containing genetic information at the location on the chromosome of the CNV region.

10. The method of claim 1, wherein matching the expression levels of the genetic factors for each of the persons is performed by matching the expression levels of micro-RNAs (miRNAs) and genes in the persons, including the plurality of patients having the specific decrease, for each of the persons, and the analysis of any one or more comprises a step of performing correlation analysis of the miRNAs and genes corresponding thereto to select genes showing negative (−) or positive (+) correlation, and selecting genes corresponding to miRNAs related to the specific disease from among the selected genes showing negative (−) or positive (+) correlation.

11. The method of claim 10, wherein the miRNAs related to the specific disease are miRNAs known to be related to the specific disease.

12. A method for discovering biomarkers by mechanism analysis, the method comprising the steps of:
classifying genes, belonging to a candidate gene group suitable for use as biomarkers of disease, as a group related to the mechanism of action of a specific disease; and
comparing the expression levels of genes of the classified group in a plurality of patient groups having the specific disease and a normal person group to select genes which are expressed more highly in the patient groups.

13. The method of claim 12, wherein the candidate gene group includes genes obtained by the method of claim 1.

14. The method of claim 12, wherein the candidate group includes genes obtained by the method of claim 3, genes obtained by the method of claim 7, and genes obtained by the method of claim 10.

15. The method of claim 12, wherein classifying the genes belonging to the candidate gene group as the group related to the mechanism of action of the specific disease is performed by comparing the expression levels of genes between the plurality of patient groups having the specific disease and the normal person group to select a mechanism of action of a disease, including genes which are expressed more highly in the patient groups, as a group related to be the mechanism of action of the specific disease.

16. The method of claim 12, wherein selecting the genes which are expressed more highly in the patient groups having the specific disease is performed by selecting the genes, which are more highly expressed in the patient groups, by performing T-test for the patient groups having the specific disease and the normal person group.

17. The method of claim 12, wherein comparing the expression levels of genes of the classified group to select genes which are expressed more highly in the patient groups is performed by first performing T-test for genes of the classified group, which have high expression levels, to select genes which are more highly expressed in the patient groups.

18. Breast cancer-related biomarkers including genes shown in Table 1.

19. The biomarkers of claim 18, wherein the biomarkers allow identification of subtypes of breast cancer.

20. A breast cancer test kit comprising: a microarray including probes corresponding to the biomarkers of claim 18; and an optical measurement device for measuring changes in expressions of the genes.
